(19) United States
(12) Patent Application Publication
(10) Pub. No.: US 2025/0291122 A1
(43) Pub. Date: Sep. 18, 2025

(54) Holding Device for a Light Guide Body, Mounting Method for Mounting a Light Guide Body to a Holding Device and Mounting Device

(71) Applicant: ZKW Group GmbH, Wieselburg (AT)

(72) Inventors: Stefan ETLINGER, St. Pölten (AT); Christian PRAGER, Waidhofen an der Ybbs (AT); Leopold PRITZL, Bergland (AT); Christian BANDION, Hafnerbach (AT); Eva STEINER, Ferschnitz (AT)

(21) Appl. No.: 19/075,930

(22) Filed: Mar. 11, 2025

(30) Foreign Application Priority Data
Mar. 18, 2024 (EP) 24164137.2

(51) Int. Cl. G02B 6/36; F21S 41/24; F21Y 111/00; G02B 6/38

(52) U.S. Cl. CPC G02B 6/3636; F21S 41/24; G02B 6/3898; F21Y 2111/00

(57) ABSTRACT

A holding device for a light guide body includes a holding body that includes a light guide receiver and that is formed from a first holding body part and a second holding body part. The light guide receiver is formed as a depression which is delimited on opposite sides by two enclosing sections of the first holding body part. The second holding body part is connected to the first holding body part such that, by an elastic deformation of the second holding body part, a width of an opening is increased by spreading apart the two enclosing sections so that the light guide body can be inserted into the light guide receiver. After removal of the deformation force, the holding body returns to its basic shape, whereby the enclosing sections enclose the light guide body inserted into the depression, and the light guide body is clamped by the enclosing sections.

### CROSS-REFERENCE TO RELATED APPLICATIONS

This application claims priority to European Patent Application No. 24164137.2, filed Mar. 18, 2024, which is incorporated herein by reference.

### TECHNICAL FIELD

The invention relates to a holding device for an, in particular elongated, light guide body, for example in the form of an, e.g. flexible, optical fiber, wherein the holding device comprises a holding body, wherein the holding body comprises a light guide receiver for the light guide body, wherein the holding body is formed from two holding body parts, a first holding body part and a second holding body part, wherein the first holding body part, the so-called inner holding body part, is formed from a first plastic as a soft component, wherein the two holding body parts are preferably formed from different plastics, and the second holding body part is preferably formed from a second plastic as a hard component, and wherein the first holding body part and the second holding body part, the so-cold outer holding body part, are firmly connected to one another and form the holding body.

Furthermore, the invention relates to a mounting method for mounting at least one light guide body to such a holding device.

The invention also relates to a mounting device for carrying out the mounting method for mounting at least one light guide body to the holding device.

Finally, the invention also relates to a lighting device for a vehicle, and a vehicle with at least one such lighting device.

### TECHNICAL BACKGROUND

Elongated light guiding bodies, such as light guide fibers/optical fibers, have a longitudinal extension and can be configured to couple out light coupled into the optical fiber at least in sections laterally, i.e. perpendicular, to the longitudinal extension of the optical fiber. For this purpose, such optical fibers can contain scattering particles and/or scattering structures.

Optical fibers are used, for example, in automotive headlights and automotive lighting devices in a wide variety of applications, such as in daytime running lights and position lamps, or in turn signals, to generate light distributions, also in adaptive headlights, for example, or as design elements by shaping and arranging optical fibers in various shapes and patterns to create aesthetic design elements in the headlight or lighting device. This enables vehicle manufacturers to create individual and eye-catching headlight designs that contribute to the identity of the vehicle and serve to individualize a driver.

Such lighting devices often have at least one light source with which, for example, one or more light distributions (low beam, high beam, etc.) or signal light functions (e.g., cornering light) can be generated. The at least one light source can be one or more LEDs, for example, but can also be a more complex arrangement of light-emitting elements, such as LEDs, which interact with light shaping means (e.g., reflectors, projection lenses, light guide bodies, etc.) to generate the desired light distribution(s) or light function(s).

For the light guide fiber(s) or optical fiber(s), one or more separate additional light sources are usually provided, with which light is fed into the optical fiber(s) at one end (or at the ends) of the optical fiber(s) and propagates in said optical fiber(s) in the longitudinal direction of the optical fiber or optical fibers and emerges from this or these, for example by light scattering on the mantle surface of the optical fiber and/or on scattering structures, so that the optical fiber is illuminated.

In typical applications, the optical fibers are attached to a holder that is mounted in a housing, such as the housing of a vehicle headlight or a vehicle tail light, or in a housing of a lighting device that is mounted on a vehicle side area. However, lighting devices for the vehicle interior can also have such a configuration.

The housing of such a lighting device, in which the one or more light sources are typically arranged, is covered or closed by a translucent, transparent plate, which in connection with lighting devices for a motor vehicle is often referred to as a cover plate, cover pane, cover disk or cover lens. The cover plate is transparent in at least part of the wavelength range of the light emitted by the at least one light source; typically, this wavelength range is in the visible and/or IR wavelength range.

It is often desirable to position the light guide fiber as close as possible to the transparent plate in order to achieve an optimum lighting effect, which is particularly advantageous in connection with the use of the light guide fiber as a design element. For example, such positioning is advantageous for achieving so-called “linear” lighting effects or linear lighting phenomena, which result in light patterns that have a large extension in one direction and a small extension in the transverse direction; narrow, line-shaped light impressions are created, which act as contour or design lines, for example.

However, the use of light guide fibers, for example in conjunction with a transparent plate, is not only of interest in the automotive lighting sector; rather, the use of light guide fibers can also be of interest in connection with general lighting devices, e.g. lighting devices for lighting living or working spaces, street lighting, etc., in which a translucent, transparent plate is provided, which, for example, closes off a housing of the lighting device.

In such applications, too, at least one light source is typically provided to implement a basic function of the lighting device, and the at least one light guide fiber is used-with the use of at least one additional light source-to implement an additional light function, for example to implement a design light.

Elongated light guide bodies, such as light guide fibers, can be used in a variety of ways. They are often flexible and can be adapted to a wide variety of shapes. However, this makes installation tedious and complicated and can result in a wavy appearance.

### SUMMARY OF THE INVENTION

It is an object of the invention to provide a solution for how a light guide fiber (or light guide fibers) can be positioned stably in a defined position, for example as close as possible to a transparent plate, such as a cover plate, in a simple and cost-effective manner.

This object is solved with a holding device initially mentioned in that, according to the invention, wherein the first holding body part comprises the light guide receiver, wherein the light guide receiver is formed as an elongated depression which extends along a curve, for example a straight line, in particular along a defined length, preferably over an entire longitudinal extent of the holding body, wherein the first holding body part comprises two enclosing sections which delimit the depression on opposite sites, and wherein the light guide receiver comprises an opening which is formed on a side of the first holding body part facing away from the second holding body part and is delimited by the two enclosing sections, wherein, in a basic shape of the holding body, the opening has a width, and wherein the second holding body part is configured such that it is elastically deformable by the application of an external force, and the second holding body part is connected to the first holding body part such that, by an elastic deformation of the second holding body part, the width of the opening with respect to the basic shape of the holding body, in which no external force acts, is increased by spreading apart the two enclosing sections of the first holding body part in such a way that the light guide body can be inserted into the light guide receiver, and wherein after removal of the external force, the holding body essentially returns to its basic form, so that the enclosing sections enclose the light guide body inserted into the depression, and the light guide body is clamped by the enclosing sections.

The invention allows a purely mechanical mounting of the light guide body without any adhesive, whereby adhesive and one or more work steps can be saved, so that a cost-effective mounting of the light guide body can be realized.

The invention also permits a mechanical mounting.

Further advantageous embodiments of the invention are described in the dependent claims.

It is advantageous that the width of the opening in the basic shape is smaller than the smallest cross-sectional dimension of the light guide body.

The cross-section of the depression is approximately circular, for example. The diameter d of the depression-in the basic shape-is the same or preferably slightly smaller than the diameter D of the light guide body, which preferably also has a circular cross-section. In this way, reliable and stable clamping of the light guide body in the depression can be ensured.

Preferably, the holding device is configured such that a clamping effect occurs over the entire length of the depression. However, it is also possible for the clamping effect to only occur in certain sections; in the other sections, for example, the depression can also be larger so that no clamping occurs there.

For example, the depression has an essentially circular cross-section in cross-sectional planes perpendicular to the curve and the characteristic variable in this case is the diameter d of the circular cross-section of the depression.

The relationship described here refers to the situation where the light guide holder is not spread open and no light guide body is inserted. If a light guide body is inserted, the depression or the first holding body part will be slightly deformed in the area of the depression and therefore deviate slightly from the circular shape.

The curve is a straight line, for example, but can also have a curved shape.

It may be provided that the second holding body part has a material weakening on a rear side facing away from the light guide receiver.

This makes it possible to realize the elastic deformability that allows the opening to be expanded, i.e. to increase the width w of the opening.

It may be provided that the material weakening is formed in the form of a recess on the rear side of the second holding body part, which recess preferably extends along the entire longitudinal extent of the holding body and, for example, runs parallel to the curve.

For example, it is possible that the material weakening runs parallel to the curve or that the curve and the material weakening lie in a “horizontal plane”.

The material weakening can be realized in the form of a recess or depression in the second holding body part.

Furthermore, it can be provided that the second holding body portion comprises at least one lever section acting as a lever arm, which is arranged with respect to the rear side such that an external force can be applied to the lever section, the direction vector of which does not pass through the material weakening.

The force acts transversely to the lever arm or perpendicular to the lever arm, for example, and causes the second holding body part and thus the opening of the depression to be spread open.

It can also be advantageous if the first holding body part has a material weakening on an inner side facing away from the second holding body part.

This allows a simpler and more defined spreading of the depression.

Preferably, the material weakening is formed in the form of a recess on the inner side of the first holding body part, which recess preferably extends along the entire longitudinal extent of the holding body, and extends, for example, parallel to the curve and/or parallel to the material weakening of the second retaining body part, wherein, for example, the material weakening of the first retaining body part lies opposite the material weakening of the second retaining body part.

Furthermore, it may be provided that the first holding body part is configured, in a front region facing away from the second holding body part, which front region delimits the opening of the light guide receiver, in particular in the region of the enclosing sections, in such a way that the front region or the enclosing sections project beyond the light guide body arranged in the depression.

It may be provided that the second holding body part comprises a mounting portion, which is preferably formed integrally with the second holding body part, in particular from the same material, wherein, for example, the holding body can be fastened with respect to a housing or a cover plate by means of the mounting portion.

It may be provided that the holding body is an injection-molded multi-component part which is formed from at least the first and the second plastic, the first plastic being connected to the second plastic as a soft component and the second plastic as a hard component in the injection molding.

For example, the hard component is made of a thermoplastic, in particular PC/ABS (polycarbonate/acrylonitrile butadiene styrene), PMMA, for example with a glass fiber content, and the soft component is made of a thermoplastic elastomer (TPE) or silicone.

Furthermore, as already mentioned, the invention relates to a mounting method for mounting at least one light guide body to the holding device described above, the mounting method comprising the following steps:
a) detachably mounting the light guide body in a first mounting device component of a mounting device;
b) detachably mounting of the holding device in a second mounting device component;
c) applying a force to the holding device in such a way that the width of the opening is increased so that the light guide body can be inserted into the light guide receiver of the holding device;
d) combining the first mounting device component and the second mounting device component so that the light guide body received in the first mounting device component is introduced into the light guide receiver;
e) detaching the light guide body from the first mounting device component;
f) removing the applied force so that the opening essentially closes to its original width of the basic shape, whereby the light guide body is clamped in the depression of the light guide receiver and held against falling out of the opening; whereby steps e) and f) can be performed simultaneously or in any order,
g) removing the first mounting device component from the second mounting device component.

In the course of the mounting process, it may be provided that the light guide body is received along a, for example curved, laying path in the first mounting device component. Preferably, the laying path is congruent with the shape or course of the light guide receiver.

It may be provided that the first mounting device component comprises vacuum nozzles, which vacuum nozzles are configured to hold the at least one light guide body in a detachable manner by negative pressure.

The invention also relates to a mounting device for carrying out the mounting method, wherein the mounting device comprises:
a first mounting device component for detachably receiving the light guide body,
a second mounting device component for detachably receiving the holding device, and
a device for reversibly applying a force to the holding device in such a way that the width of the opening is increased so that the light guide body can be inserted into the light guide receiver of the holding device,
wherein the mounting device is configured to bring together the first mounting device component and the second mounting device component in such a way that the at least one light guide body received in the first mounting device component is introduced into the light guide receiver of the holding device.

It may be provided that the first mounting device component comprises vacuum nozzles, which vacuum nozzles are configured to hold the at least one light guide body in a detachable manner by negative pressure.

The invention also relates to a lighting device for a vehicle, the lighting device comprising a cover plate and a holding device which holds at least one light guide body, the holding device being fastened to the cover plate in such a way that the at least one light guide body is held on a side, in particular an inner side, opposite the cover plate.

The holding device can be attached, preferably with its mounting section, e.g., to a cover plate of the lighting device itself, preferably to a non-transparent region of the cover plate, e.g., a black component in the case of a 2K cover plate.

In the lighting device, it may be provided that the light guide body is held at a distance greater than zero from the side, in particular the inner side of the cover plate, for example wherein the front region of the first holding body part, in particular the enclosing sections projecting beyond the light guide body arranged in the depression, rest against the side of the cover plate.

### BRIEF DESCRIPTION OF THE DRAWINGS

The invention is explained in more detail below with reference to exemplary drawings.

FIG. 1 is a perspective view of a holding device according to the invention.

FIG. 2 shows the holding device from FIG. 1 in a vertical section in a plane Ev in its basic shape.

FIG. 2A shows the holding device from FIG. 1 and FIG. 2 in a state spread open by exerting a force.

FIG. 3 is a perspective view of the holding device from FIG. 1 with the elongated light guide body held in place.

FIG. 4 shows the arrangement from FIG. 3 in a vertical section in the plane Ev.
FIG. 5 shows a vertical section of the holding device together with the light guide body in the mounted state in the area of a cover plate.

FIGS. 6A-6E shows a mounting device and the steps of mounting an elongated light guide body in a holding device according to the invention.

### DETAILED DESCRIPTION OF EMBODIMENTS

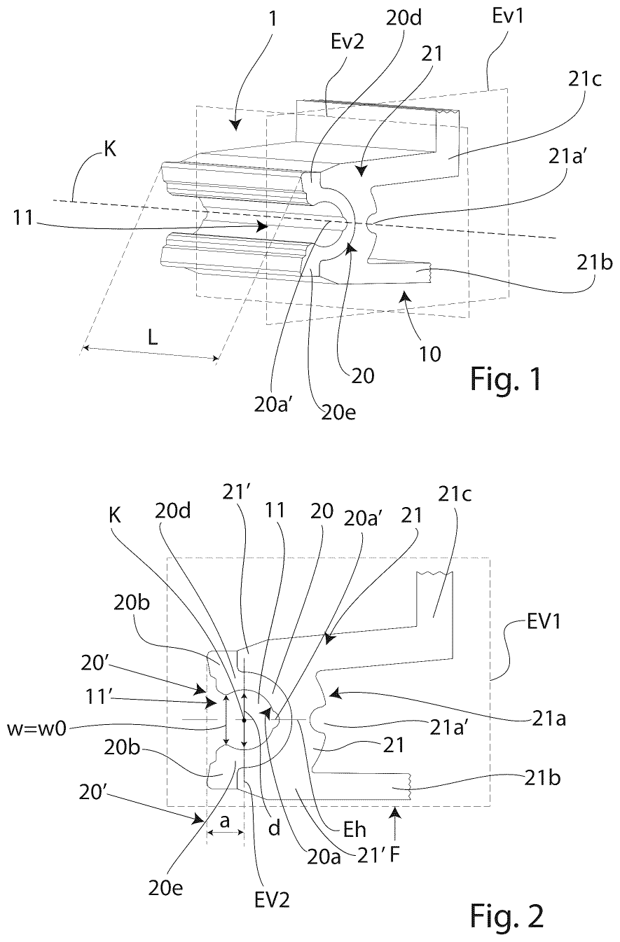

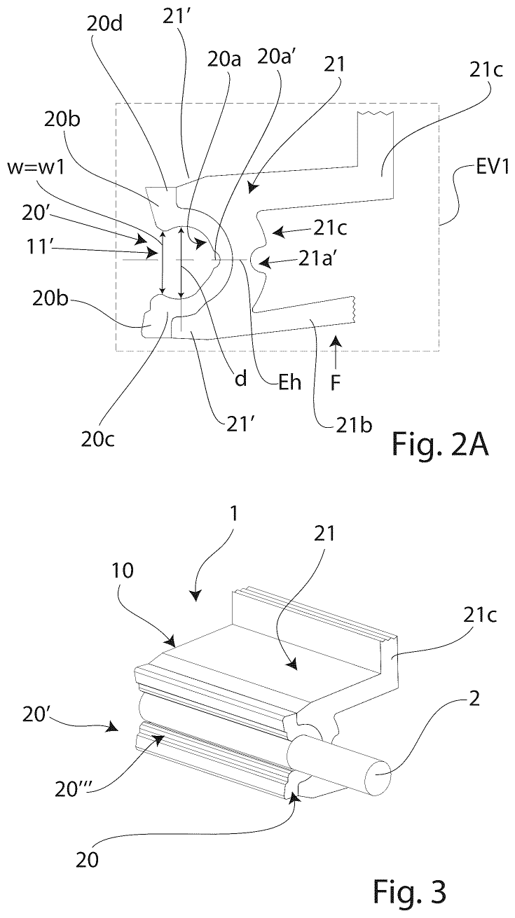

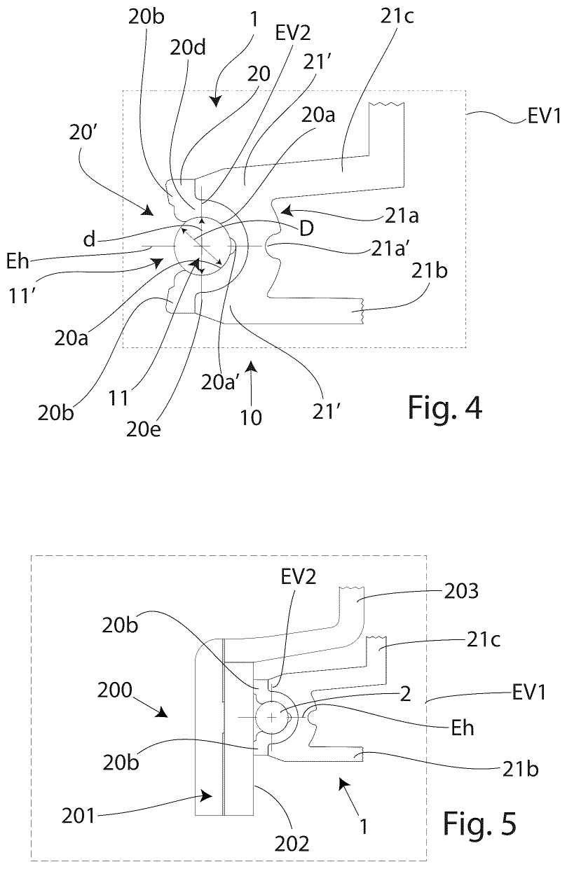

FIGS. 1 and 2 show a holding device 1 for holding an, in particular elongated, light guide body 2, for example in the form of a flexible optical fiber. FIGS. 3 and 4 show the holding device 1 with the light guide body 2 held by it.

The holding device 1 comprises a holding body 10, wherein the holding body 10 comprises a light guide receiver 11 for the light guide body 2. The holding body 10 in turn comprises two holding body parts, a first holding body part 20 and a second holding body part 21. The two holding body parts 20, 21 are formed from different plastics, wherein the first holding body part 20, the so-called inner holding body part 20, is formed from a first plastic as a soft component, and the second holding body part 21, the so-called outer holding body part 21, is formed from a second plastic as a hard component.

The first holding body part 20 and the second holding body part 21 are firmly connected to one another other and form the holding body 10.

Preferably, the holding body 10 is an injection-molded multi-component part which is formed from at least the first and the second plastic, the first plastic being connected to the second plastic as a soft component and the second plastic as a hard component in the injection molding.

For example, the hard component is made of a thermoplastic, in particular PC/ABS (polycarbonate/acrylonitrile butadiene styrene), PMMA, for example with a glass fiber content, and the soft component is made of a thermoplastic elastomer (TPE) or silicone.

The first holding body part 20 comprises the light guide receiver 11 for receiving the light guide body 2, the light guide receiver 11 being in the form of an elongated depression extending along a curve K in the holding body 10. For example, the holding body 10 has a longitudinal extension L and the depression extends over the entire longitudinal extension of the holding body 10.

The light guide receiver 11 is therefore preferably an elongated depression, for example in the form of a groove. The curve K is typically a straight line but can also have a curved shape.

The first holding body part 20 comprises two enclosing sections 20d, 20e, which delimit the depression on opposite sides.

The light guide receiver 11 or depression has an opening 11′, which is formed on a side 20′ of the first holding body part 20 facing away from the second holding body part 21 and is delimited by the two enclosing sections 20d, 20e.

In a basic shape of the retaining body 10, the opening 11′ has a defined width w=w0. The basic shape is the shape in which no force acts on the holding body 10 and no light guide is inserted into the depression 11.

The second holding body part 21 is configured such that that it can be elastically deformed by the application of an external force, the second holding body part 21 is connected, in particular firmly, to the first holding body part 20 such that, by an elastic deformation of the second holding body part 20, the width w of the opening 11′ with respect to the basic shape of the holding body 10, in which no external force acts, is increased by spreading apart the two enclosing sections 20d, 20e of the first holding body part 20 in such a way that the light guide body 2 can be inserted into the light guide receiver 11. For this purpose, the second holding body part 21 is configured in such a way that it grips around the first holding body part 20, in particular in the area of the enclosing sections 20d, 20e.

An external force F can, as schematically indicated in FIG. 2A, spread open the second holding body part 21, whereby the first holding body part 20, in particular the two enclosing sections 20d, 20e, is also spread open, since the second holding body part 21 and the first holding body part 20 are connected to one another, in particular firmly.

The width of the opening 11′ of the light guide receiver 11 can be expanded to a value w=w1. This value w1 can be greater than the maximum cross-sectional expansion, e.g. the diameter D of the light guide body 2, but the value w1 can also be less, so that the light guide body 2 must be pressed into the depression with a certain force. Preferably, the diameter d of the depression also increases.

After the external force F is removed, the holding body 10 essentially returns to its basic shape so that the enclosing sections 20d, 20e grip around the light guide body 2 inserted into the depression, and the light guide body 2 is clamped by the enclosing sections 20d, 20e.

The term “essentially into the basic shape” means that the holding body 10 attempts to return to its original shape, the basic shape, after the external force has been removed; without the light guide body 2 inserted, the holding body 10 would actually return to this basic shape. With the light guide body 2 inserted, which is preferably slightly larger in cross-section than the depression, the holding body 10 can no longer return completely to its basic shape, which exerts a clamping force on the light guide body 2 and clamps it in the depression.

As shown in FIG. 1, the width w is measured in cross-sectional planes Ev1 perpendicular to the curve K. Preferably, the width w—in the basic shape—is identical over the entire length L of the holding body 10. Even in the expanded state, the (then larger) width is usually constant over the entire length, i.e. identical in all cross-sections along the longitudinal extension.

The first holding body part 20 is preferably configured in such a way that the width w=w0 of the opening 11′ in the basic shape is smaller than the smallest cross-sectional dimension D of the light guide body 2.

The cross-section of the depression is approximately circular, for example. The diameter d of the depression-in the basic shape-is the same or preferably slightly smaller than the diameter D of the light guide body 2, which also has a circular cross-section, for example. In this way, reliable and stable clamping of the light guide body 2 in the depression can be ensured.

Preferably, the holding device 1 is configured in such a way that a clamping effect occurs over the entire length of the depression. However, it is also possible for the clamping effect to only occur in certain sections; in the other sections, for example, the depression can also be larger so that no clamping occurs there.

The relationship described here refers to the situation in which the light guide receiver 11 is not spread open and no light guide body 2 is inserted. If a light guide body 2 is inserted, the depression or the first holding body part 20 will be slightly deformed in the area of the depression and therefore deviate slightly from the circular shape.

It is advantageously provided that the second holding body part 21 has a material weakening 21a′ on a rear side 21a facing away from the light guide receiver 11.

In this way, the elastic deformability that allows the opening 11′ to be spread, i.e. the width w of the opening 11′ to be increased, can be realized.

As shown in the figures, it may be provided that the material weakening 21a′ is in the form of a recess on the rear side 21a of the second holding body part 21, which recess preferably extends along the entire longitudinal extent L of the holding body 10 and runs parallel to the curve K, for example. The material weakening 21a′ can be realized in the form of a recess or depression in the second holding body part 21.

For example, it may be provided that the material weakening 21a′ runs parallel to the curve K and/or that the curve K and the material weakening lie in a horizontal plane Eh.

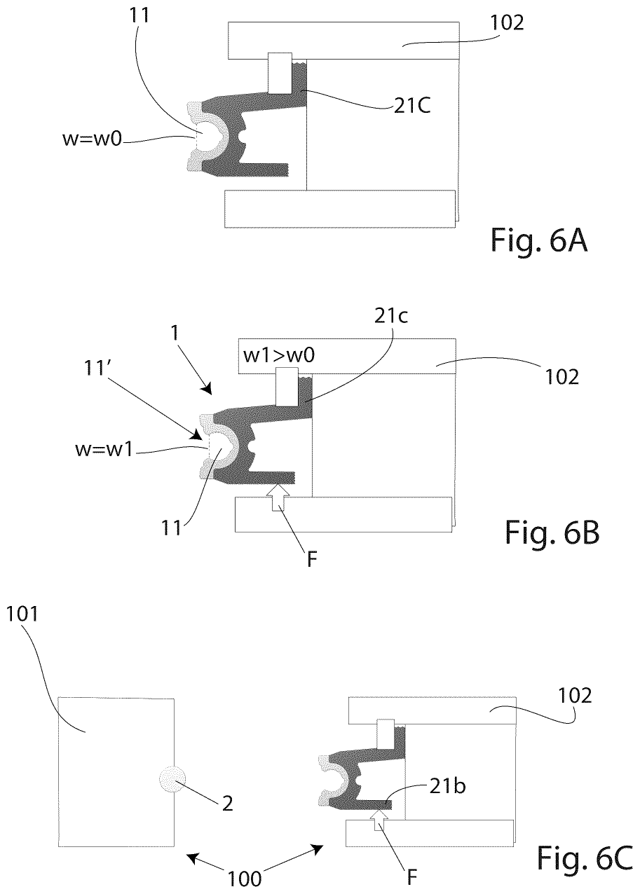

The terms “horizontal plane” Eh and “vertical plane” Ev1, Ev2 refer to the specific embodiment shown in FIGS. 1-5. In this—assumed to be flat for simplification, e.g. of a lighting device 200 (see FIG. 5)—lies in a vertical plane which is parallel to the second vertical plane Ev2.

The light guide body 2 or curve K is assumed to be a straight line. The first vertical plane Ev1 or first vertical sectional planes through the light guide body 2 or through the depression, to which first vertical planes/sectional planes the Ev1 curve K or straight line runs perpendicularly, intersect the second vertical plane Ev2 at 90°. The planes Eh, Ev1, Ev2 mentioned in this application example are therefore actually horizontal or vertical planes.

In practice, however, the position of the light guide body 2 (which of course does not necessarily have to be straight) can be different, depending on the application and specific configuration, i.e. the light guide body 2 and thus the holding device 1 can be oriented in space in a different way from the orientation shown in FIGS. 1-5. The plane designated as horizontal plane Eh or the planes designated as vertical planes Ev1, Ev2 can then assume a position other than horizontal or vertical, or the horizontal plane can be a vertical plane and/or vice versa.

As shown, it is advantageously provided that the second holding body part 21 comprises a lever section 21b acting as a lever arm, which is arranged with respect to the rear side 21a in such a way that an external force F can be applied to the lever section 21b, the direction vector of which does not pass through the material weakening 21a′, and which results in the second holding body part 21 being spread open by the external force F about its material weakening 21a′. The material weakening 21a′ de facto realizes a virtual pivot axis for sections 21′ of the second holding body part 21, which embrace the first holding body part 20. The two sections 21′ are “pivoted” about this virtual pivot axis and spread apart, and thus also the first holding body part 20.

Furthermore, it is advantageous if, as shown, the first holding body part 20 also has a material weakening 20a′ on an inner side 20a facing away from the second retaining body part 21.

This allows a simpler and more defined spreading of the depression.

It is preferably provided that the material weakening 20a′—again in the form of a recess—is formed on the inner side 20a of the first holding body part 20, which preferably extends along the entire longitudinal extent L of the holding body 10 and, for example, runs parallel to the curve K and/or parallel to the material weakening 21a′ of the second retaining body part 21. Preferably, the material weakening 20a′ of the first holding body part 20 is opposite the material weakening 21a′ of the second holding body part 21.

Furthermore, it can be provided that the first holding body part 20 is formed in a front region 20b facing away from the second holding body part 21, which delimits the opening 11′ of the light guide receiver 11, in particular in the region of the enclosing sections 20d, 20e, in such a way that the front region 20b, which adjoins the enclosing sections 20d, 20e or is part of these enclosing sections, projects beyond the light guide body 2 arranged in the depression.

The material thickness of the first holding body part 20 is thus selected in such a way that at least in sections, preferably over the entire length L of the holding body 10, the region 20b has a normal distance a to a local vertical longitudinal center plane Ev2 of the curve K or an outer boundary 20b′ of the region 20b, which is greater than the one cross-sectional dimension, in particular in diameter D of the light guide body 2.

The first holding body part 20 thus protrudes with the region 20b over the light guide body 2 inserted into the light guide receiver 11.

FIG. 5 schematically shows a transparent cover plate 201 of a lighting device 200, e.g. a motor vehicle headlamp, wherein the cover plate 201 is fixed, for example, to a housing 203 of the lighting device 200. With the holding device 1, the light guide body 2 is positioned in the vicinity of an inner side 202 of the cover plate 201, and can be positioned as close as possible to the inner side 202 without touching it. The protruding region(s) 20b of the first holding body part 20 prevent(s) the light guide body 2 from touching the cover plate 201 or its inner side 202.

In particular, the design of the first holding body part 20 made of a soft component allows the light guide body 2 to be positioned as close as possible or desired to the cover plate 201, since the design made of a soft component means that contact between the cover plate 201 and the regions 20b, for example as a result of tolerances, is not critical and abrasion due to friction is also prevented. Positioning as close as possible to the cover plate 201 may be desirable in order to provide an optimum view of the light guide body 2.

Preferably, the region 20b also cover those areas of the second holding body part 21 which are closest to the cover plate 201, so that the second holding body part 21, which consists of a hard component, cannot come into contact with the cover plate 201.

For fixing the holding device 1 in a certain position, for example in relation to a cover plate 201 of a lighting device 200, as described with reference to FIG. 5, it is advantageous if the second holding body part 21 comprises a mounting portion 21c, which is preferably formed in one piece with the second holding body part 21, in particular from the same material.

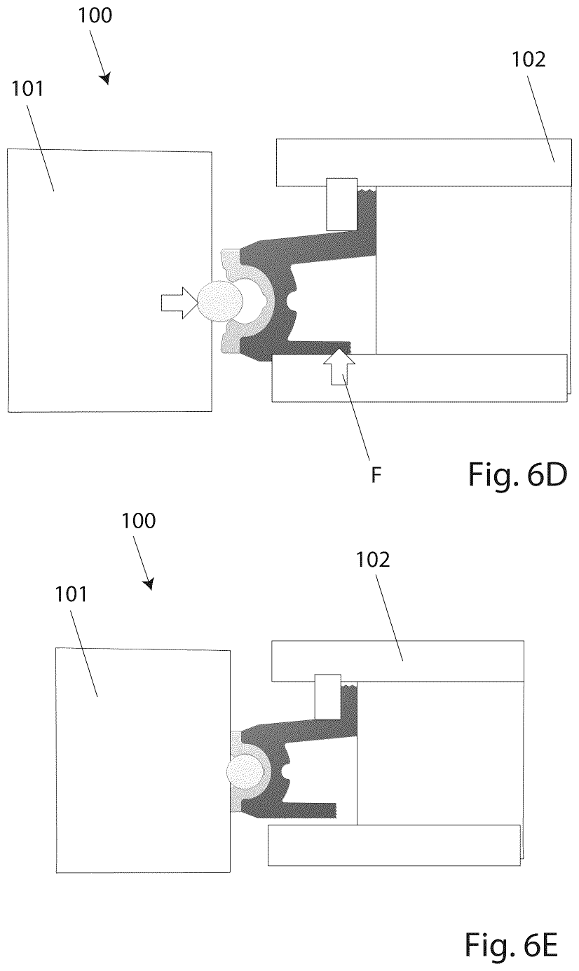

FIGS. 6A-6E also describe a mounting method for attaching a light guide body 2 to a holding device 1 with the aid of a mounting device 100.

FIGS. 6A-6E show a mounting device 100 which comprises a first mounting device component 101 for detachably receiving the light guide body 2, a second mounting device component 102 for detachably receiving the holding device 1, and a device-not shown-for reversibly applying a force to the holding device 1 in such a way that the width w of the opening 11′ of the light guide receiver 11 is increased.

The mounting device 100 is configured such that the first mounting device component 101 and the second mounting device component 102 can be brought together so that the light guide body 2 received in the first mounting device component 101 can be inserted into the light guide receiver 11 of the holding device 1.

For releasably holding the light guide body 2 on the first mounting device component 101, it may be provided that the first mounting device component 101 comprises vacuum nozzles, which vacuum nozzles are configured to releasably hold the light guide body 2 by means of negative pressure.

The mounting method comprises the following steps:
a) detachably mounting the light guide body (2 in a first mounting device component 101 of a mounting device (100);
b) detachably mounting of the holding device 1 in a second mounting device component 102; the holding device 1 can be held, for example, by its mounting portion 21c on the second mounting device component 102;

Steps a) and b) can take place simultaneously or in any order;
c) applying a force F to the holding device 1 such that the width w of the opening 11′ is increased (from a width w=w0 in the basic form to a width w1) so that the light guide body 2 can be inserted into the light guide receiver 11 of the holding device 1; (FIG. 6B, 6C)
d) combining the first mounting device component 101 and the second mounting device component 102 (FIG. 6D), so that the light guide body 2 received in the first mounting device component 101 is inserted into the light guide receiver 11; (FIG. 6E)
e) detaching the light guide body 2 from the first mounting device component 101; (FIG. 6E)
f) removing the applied force F (FIG. 6E), so that the opening 11′ essentially closes to its original width w=w0 of the basic shape, whereby the light guide body 2 is clamped in the depression of the light guide receiver 11 and held against falling out of the opening 11′;

wherein steps e) and f) may be performed simultaneously or in any order, and
g) removing the first mounting device component 101 from the second mounting device component 102.

That which is claimed is:

1. A holding device (1) for an elongated light guide body (2), the holding device comprising:
a holding body (10) which comprises a light guide receiver (11) for the light guide body (2), wherein the holding body (10) is formed from two holding body parts, a first holding body part (20) and a second holding body part (21),
wherein the first holding body part (20), a so-called inner holding body part (20), is formed from a first plastic as a soft component, wherein the two holding body parts (20, 21) are preferably formed from different plastics, and the second holding body part (21) is preferably formed from a second plastic as a hard component, and
wherein the first holding body part (20) and the second holding body part (21), the so-called outer holding body part (21), are firmly connected to one another and form the holding body (10),
wherein the first holding body part (20) comprises the light guide receiver (11), wherein the light guide receiver (11) is formed as an elongated depression which extends along a curve (K) along a defined length,
wherein the first holding body part (20) comprises two enclosing sections (20d, 20e) which delimit the depression on opposite sites,
wherein the light guide receiver (11) comprises an opening (11′) which is formed on a side (20′) of the first holding body part (20) facing away from the second holding body part (21) and is delimited by the two enclosing sections (20d, 20e), wherein, in a basic shape of the holding body (10), the opening (11′) has a width (w),
wherein the second holding body part (21) is configured such that it is elastically deformable by the application of an external force, and the second holding body part (21) is connected to the first holding body part (20) such that, by an elastic deformation of the second holding body part (20), the width (w) of the opening (11′) with respect to the basic shape of the holding body (10), in which no external force acts, is increased by spreading apart the two enclosing sections (20d, 20e) of the first holding body part (20) in such a way that the light guide body (2) can be inserted into the light guide receiver (11), and
wherein after removal of the external force, the holding body (10) essentially returns to its basic form, so that the enclosing sections (20d, 20e) enclose the light guide body (2) inserted into the depression, and the light guide body (2) is clamped by the enclosing sections (20d, 20e).

2. The holding device (1) according to claim 1, wherein the width (w) of the opening (11′) in the basic shape is smaller than the smallest cross-sectional dimension (D) of the light guide body (2).

3. The holding device (1) according to claim 1, wherein the second holding body part (21) has a material weakening (21a′) on a rear side (21a) facing away from the light guide receiver (11), wherein, for example, the material weakening (21a′) is formed in the form of a recess on the rear side (21a) of the second holding body part (21), which recess preferably extends along the entire longitudinal extent (L) of the holding body (10) and, for example, runs parallel to the curve (K).

4. The holding device (1) according to claim 1, wherein the second holding body portion (21) comprises at least one lever section (21b) acting as a lever arm, which is arranged with respect to the rear side (21a) such that an external force (F) can be applied to the lever section (21b), the direction vector of which does not pass through the material weakening (21a′).

5. The holding device (1) according to claim 1, wherein the first holding body part (20) has a material weakening (20a′) on an inner side (20a) facing away from the second holding body part (21).

6. The holding device (1) according to claim 5, wherein the material weakening (20a′) is formed in the form of a recess on the inner side (20a) of the first holding body part (20), which recess preferably extends along the entire longitudinal extent (L) of the holding body (10), and extends, for example, parallel to the curve (K) and/or parallel to the material weakening (21a′) of the second retaining body part (21), wherein, for example, the material weakening (20a′) of the first retaining body part (20) lies opposite the material weakening (21a′) of the second retaining body part (21).

7. The holding device (1) according to claim 1, wherein the first holding body part (20) is configured, in a front region (20b) facing away from the second holding body part (21), which front region (20b) delimits the opening (11′) of the light guide receiver (11), in the region of the enclosing sections (20d, 20e), in such a way that the front region (20b) or the enclosing sections (20d, 20e) project beyond the light guide body (2) arranged in the depression.

8. The holding device (1) according to claim 1, wherein the second holding body part (21) comprises a mounting portion (21c), which is preferably formed integrally with the second holding body part (21), in particular from the same material, wherein, for example, the holding body (10) can be fastened with respect to a housing or a cover plate by means of the mounting portion (21c).

9. A mounting method for mounting at least one light guide body (2) to a holding device (10) according to claim 1, wherein the mounting method comprises:
a) detachably mounting the light guide body (2) in a first mounting device component (101) of a mounting device (100);
b) detachably mounting the holding device (1) in a second mounting device component (102);
c) applying a force to the holding device (1) in such a way that the width (w) of the opening (11′) is increased so that the light guide body (2) can be inserted into the light guide receiver (11) of the holding device (1);
d) combining the first mounting device component (101) and the second mounting device component (102) so that the light guide body (2) received in the first mounting device component (101) is introduced into the light guide receiver (11);
e) detaching the light guide body (2) from the first mounting device component (101);
f) removing the applied force so that the opening (11′) essentially closes to its original width (w) of the basic shape, whereby the light guide body (2) is clamped in the depression of the light guide receiver (11) and held against falling out of the opening (11′);
wherein steps e) and f) are performed simultaneously or in any order, and
g) removing the first mounting device component (101) from the second mounting device component (102).

10. The mounting method according to claim 9, wherein the light guide body (2) is received along a, for example curved, laying path in the first mounting device component (101).

11. A mounting device (100) for carrying out the method according to claim 9 for mounting at least one light guide body (2) to a holding device (1) wherein the mounting device (100) comprises:
a first mounting device component (101) for detachably receiving the light guide body (2);
a second mounting device component (102) for detachably receiving the holding device (1); and
a device for reversibly applying a force to the holding device (1) in such a way that the width (w) of the opening (11′) is increased so that the light guide body (2) can be inserted into the light guide receiver (11) of the holding device (1),
wherein the mounting device (100) is configured to bring together the first mounting device component (101) and the second mounting device component (102) in such a way that the at least one light guide body (2) received in the first mounting device component (101) is introduced into the light guide receiver (11) of the holding device (1).

12. The mounting device (100) according to claim 11, wherein the first mounting device component (101) comprises vacuum nozzles, which are configured to hold the at least one light guide body (2) in a detachable manner by negative pressure.

13. A lighting device (200) for a vehicle, the lighting device (200) comprising:
a cover plate (201); and
a holding device (1) according to claim 1, which holds at least one light guide body (2), the holding device (1) being fastened to the cover plate (201) in such a way that the at least one light guide body (2) is held on an inner side (202) opposite the cover plate (201).

14. The lighting device (200) according to claim 13, wherein the at least one light guide body (2) is held at a distance greater than zero from the inner side (202) of the cover plate (201), for example wherein the front region (20b) of the first holding body part (20), in particular the enclosing sections (20d, 20e) projecting beyond the at least one light guide body (2) arranged in the depression, rest against the side of the cover plate (201).

15. A motor vehicle comprising: at least one lighting device (200) according to claim 14.

16. The holding device according to claim 1, wherein the elongated light guide body (2) is in the form of an optical fiber.

17. The holding device according to claim 1, wherein the curve (K) is a straight line.

18. The holding device according to claim 1, wherein the elongated depression extends along the curve (K) along the defined length over an entire longitudinal extent (L) of the holding body (10).

19. The lighting device according to claim 13, wherein the at least one light guide body (2) is in the form of an optical fiber.
